(19) United States
(12) Patent Application Publication
(10) Pub. No.: US 2005/0034034 A1
(43) Pub. Date: Feb. 10, 2005

(54) Control device with rewriteable control data

(75) Inventor: Yoji Kamada, Ebina-shi (JP)

Correspondence Address: FOLEY AND LARDNER;SUITE 500, 3000 K STREET NW, WASHINGTON, DC, 20007, US

(73) Assignee: NISSAN MOTOR CO., LTD.

(21) Appl. No.: 10/895,291

(22) Filed: Jul. 21, 2004

(30) Foreign Application Priority Data
Aug. 6, 2003 (JP) 2003-287964

(51) Int. Cl. G06F 11/00

(52) U.S. Cl. 714/52

(57) ABSTRACT

A control device has a rewriteable flash memory for storing a program or data, and a CVN calculating unit for calculating a CVN value for guaranteeing the content of the flash memory. The control device also has a rewriteable EEPROM for storing a CVN calculation storage value. When it is determined that the flash memory was not rewritten, the CVN calculation storage value stored in the EEPROM is outputted before the CVN calculation is performed, and a calculation result is outputted. On the other hand, when the flash memory was rewritten, the calculation result is outputted after the CVN calculation is complete.

### BACKGROUND OF THE INVENTION

1. Field of the Invention

The present invention relates to an improvement in a control device used in a vehicle or the like, and more particularly to detecting illegitimate alteration when a program and data used for control are stored into a rewriteable storage unit.

2. Description of the Related Art

In an automobile or other such vehicle, engine control, transmission control, break control, and the like are performed electronically by a control unit, the main part of which is a microprocessor. In the engine control, in order to achieve a balance between engine output and exhaust gas performance, optimum control data (maps, etc.) that are obtained through experiments and the like are stored into an EEPROM, a flash memory, or other such nonvolatile storage unit, and the controls are performed.

On the other hand, it cannot be ignored that one portion of the market is not concerned with reduction of exhaust gas performance, and thus performs illegal overhauls involving rewriting the optimally set control data in order to improve just engine output. Therefore, in North America, as an aspect of exhaust gas regulation, in order to prevent illegal overhauling of the control unit, it is required (in America's OBD II statute, etc.) to output a CVN (Calibration Verification Number) to a diagnostic device.

In a case where a checksum is calculated to output the legitimacy of a program and control data as the CVN, the checksum is a total sum of binary data that is simply added together. Therefore, if the added/subtracted amount is erased with dummy data or the like, the program could be illegitimately altered without changing the CVN.

In order to prevent this, the control device data is handled as follows. Values stored in each address where the data is present serve as address data which indicate the addresses of the data, and the original data is stored in the addresses indicated by the address data.

Then, in the calculation of the CVN value, the total sum of the original data indicated by the above-mentioned address data is obtained as a CVN value. This CVN value and a known CVN reference value that is set in advance are then compared to determine whether or not the illegitimate alteration occurred (See JP 2003-58424 A).

### SUMMARY OF THE INVENTION

Incidentally, in the above-mentioned North American OBD II statute and the like, among control devices that are mounted on vehicles, control devices that influence exhaust performance are obliged to calculate a CVN, which is a value for guaranteeing the content of software written therein, when a diagnostic device is connected to the control device, and must send the calculation result to the diagnostic device and display it.

However, the above-mentioned conventional example calculates the CVN with respect to all storage, areas where the control device software (program and data) is written. Therefore, much time is needed until the CVN is displayed, and there was a problem in that the legitimacy of the software could not be judged quickly. As to the number of times by which this calculation is performed, the calculations must be repeated by at least “total storage capacity÷storage management unit”. For example, when the total storage capacity=512 Kbytes, and the storage management unit=1 byte=1,024 bytes, the calculations must be performed 512×1,024÷1=524,288 times.

It should be noted that, in order to detect partial rewriting as well, the calculations must be performed for the entire storage capacity.

Furthermore, in a case where an EEPROM, a flash memory, or other storage element is employed as the nonvolatile storage unit, a maximum number of rewrite times is set, and when this maximum is exceeded, writing may become impossible. Therefore, when used for long periods of time as in an automobile of other vehicle, there was a problem in that the life of the storage elements would shrink if the CVN were calculated and written into the nonvolatile storage unit every time the control device operates.

The present invention was made in light of the above-mentioned problems, and it is therefore an object of the invention to display a CVN on a diagnostic device quickly and facilitate a judgment of legitimacy.

According to the present invention, there is provided a control device with rewriteable control data, including: a first storage unit that stores one of a program and data and is constituted in a rewriteable fashion; a CVN calculating unit that calculates a content guaranteeing value for guaranteeing a content of the first storage unit; a second storage unit that stores a reference value of the content guaranteeing value and is constituted in a rewriteable fashion; a rewrite determining unit that determines that the first storage unit was rewritten; a first verifying unit that, when the determining unit determines that the first storage unit was not rewritten, outputs the reference value stored in the second storage unit before the CVN calculating unit performs the calculation, and outputs a calculation result; and a second verifying unit that, when the determining unit determines that the first storage unit was rewritten, outputs a calculation result after calculation of the CVN calculating unit is complete.

Therefore, according to the present invention, when it is determined that the program and the data in the first storage unit have not been rewritten, the reference value of the content guaranteeing value stored in the second storage unit provided separately from the first storage unit is first outputted, and after that, when the calculation of the content guaranteeing value is complete, the content guaranteeing value calculation result is outputted, and when it is determined that the program and the data written in the first storage unit were rewritten, the output is not performed until the calculation of the content guaranteeing value is complete. Therefore, when verifying the legitimacy of the program and the data of the control device, it becomes possible to judge the legitimacy easily and quickly based on whether or not the reference value is outputted immediately. For example, the output of the control device connects to a diagnostic device, and when the reference value is not outputted immediately by the diagnostic device, this guarantees that the first storage unit has not been rewritten. When it takes time until the content guaranteeing value is outputted to the diagnostic device, it can suggest that rewriting did occur.

These and other objects, features, aspects and advantages of the present invention will be become apparent to those skilled in the art from the following detailed description, which, taken in conjunction with the annexed drawings, discloses a preferred embodiments of the present invention.

### BRIEF DESCRIPTION OF THE DRAWINGS

FIG. 1 is a system diagram showing a control device according to an embodiment of the present invention.

FIG. 2 is a flowchart showing an example of CVN calculation processing performed by the control device.

FIG. 3 is an explanatory diagram showing the CVN calculation.

### DETAILED DESCRIPTION OF THE PREFERRED EMBODIMENTS

Below, explanation is given regarding an embodiment of the present invention, based on the attached drawings.

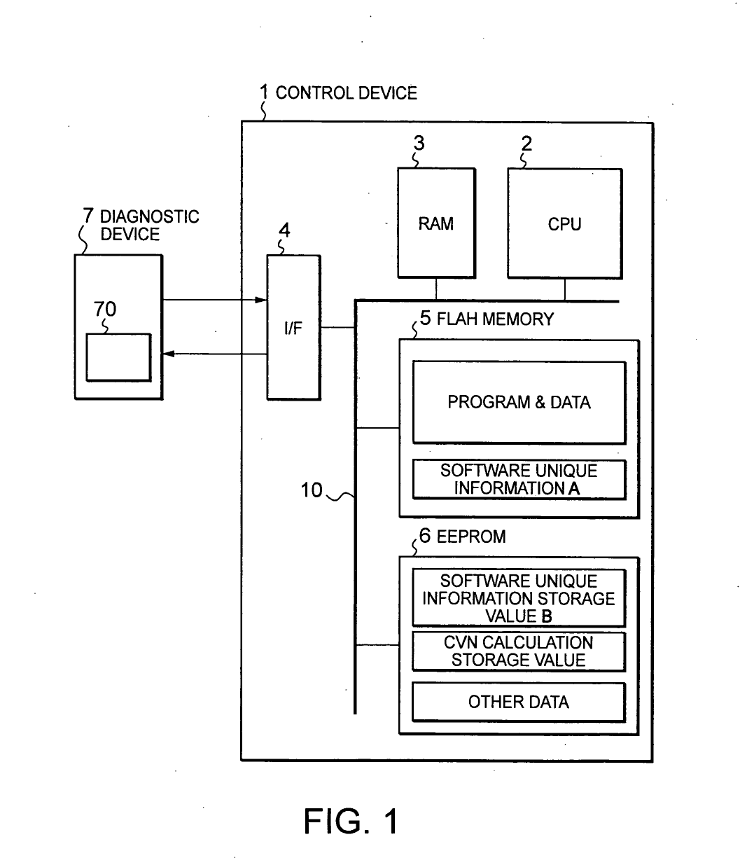

FIG. 1 shows a state where a diagnostic device 7 is connected to a control device 1 mounted on a vehicle.

A control device 1 controls an engine of a vehicle for example, and is constituted mainly by a CPU 2 for performing calculations, a RAM 3 for providing a work area and the like, an interface 4 for inputting and outputting a signal to/from an external area, a flash memory 5 storing a program, data, etc., and an EEPROM (=E²PROM, Electrically Erasable Programmable Read-Only Memory) 6 storing data such as a CVN calculation result storage value for guaranteeing the content of software stored in the flash memory 5. Each of the foregoing is connected via a bus 10.

The CPU 2 reads out the program and the data stored in the flash memory 5 (first storage unit), and also calculates a command value for a controlled object based on such things as a value detected by a sensor (not shown) which is connected to the interface 4.

Stored in the flash memory 5 are a program for executing control, and data obtained from experiments and the like. Further, software unique information A for identifying the program and the data are also written into the flash memory 5. The software unique information A has the program's version code, the data's version code, the control device's parts code, and other such codes unique to the software. Therefore, the content of the software can be specified using the software unique information A.

Furthermore, since the flash memory 5 is writeable, the software unique information A can be rewritten by upgrading the program, upgrading the data, etc.

Written in the EEPROM 6 (second storage unit) are a CVN calculation storage value (reference value for guaranteeing the software content), a software unique information storage value B, an error code used in controls, etc.

The CVN calculation storage value is rewritten when the content in the flash memory 5 is rewritten and the CVN (value guaranteeing the content of the software) calculation result has changed. Therefore, in the initialized state, the CVN which is the total sum of the data in the flash memory 5 is written here.

The software unique information storage value B is rewritten when the content of the program or the data is rewritten and the version code or parts code has changed. Therefore, in the initialized state, the code corresponding to the content in the flash memory 5 (i.e., the software's unique code) is written here.

When the diagnostic device 7 connected to the interface 4 boots up, it requests the control device 1 for the CVN calculation result, and outputs the CVN calculation result returned from the control device 1 to a display device 70 or other such output unit.

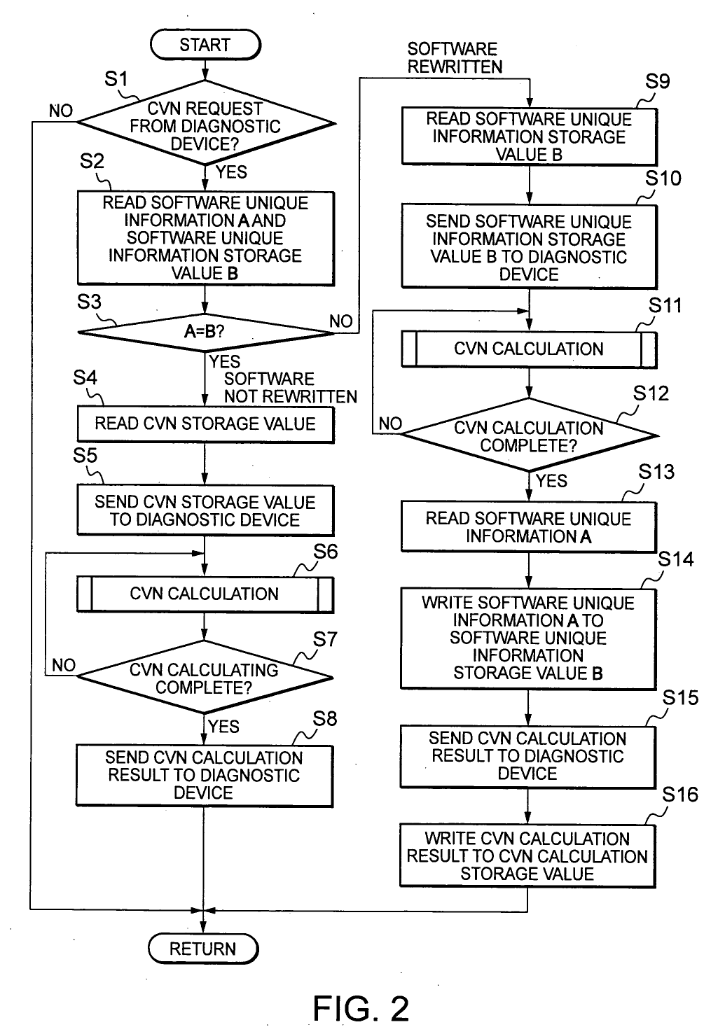

FIG. 2 is a flowchart showing an example of CVN calculation processing (self-diagnosis processing) executed by the control device 1 when the diagnostic device 7 is connected. This processing is executed repeatedly every given duration of time (e.g., tens of msec).

At step S1, it is determined whether or not there was a CVN send request from the diagnostic device 7. When there is a request, the processing advances to step S2. When not, the processing ends temporarily.

At step S2, the software unique information A is read from the flash memory 5 and the software unique information storage value B is read from the EEPROM 6.

At step S3, it is determined whether or not the software unique information A in the flash memory 5 is equivalent to the software unique information storage value B in the EEPROM 6. When A=B, then it is determined that the flash memory 5 has not been rewritten, and the processing advances to step S4. On the other hand, when A≠B, then it is determined that the flash memory 5 has been rewritten, and the processing advances to step S9.

At step S4, when it is determined that rewriting has not occurred, the CVN calculation storage value is read from the EEPROM 6. At step S5, this CVN calculation storage value is sent to the diagnostic device 7. At this time, the CVN calculation result has not yet been outputted, but since the flash memory 5 has not been rewritten, the CVN calculation result is the same as the CVN calculation storage value.

Therefore, when it is determined that no rewrite has occurred, the CVN calculation storage value is sent to the diagnostic device 7, whereby an operator of the diagnostic device 7 can immediately confirm the value of the CVN.

Next, at step S6, the CVN calculation is started with respect to all storage areas of the flash memory 5. At step S7, it is determined whether or not the CVN calculations for all the storage areas are complete. Step S6 is repeatedly executed until these calculations are complete.

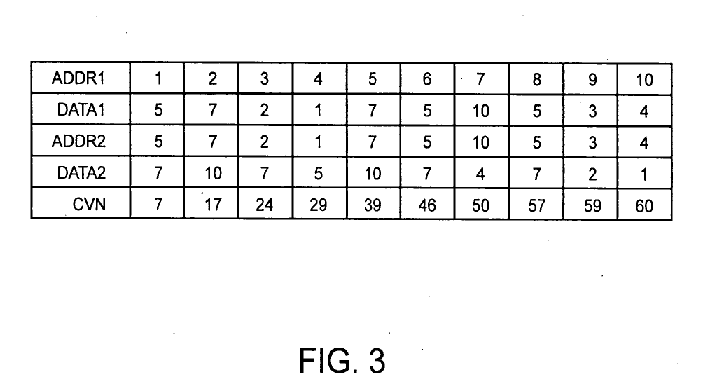

The CVN calculation is performed as in the above-mentioned conventional example. For example, as shown in FIG. 3, DATA 1 in the storage area address ADDR 1 of the flash memory 5 is read. The DATA 1 is read as an address ADDR 2, and the data stored in the ADDR 2 is read as data DATA 2 that is used for performing the controls. The total sum of the DATA 2 serves as the CVN.

Then, when the determination at step S7 indicates that the CVN calculation is finished for all the storage areas, at step S8, the CVN calculation result that is actually calculated is sent to the diagnostic device 7 and the processing ends.

On the other hand, when the above-mentioned determination at step S3 indicates that A≠B and it is determined that the flash memory 5 was not rewritten, the processing advances to step S9 and the software unique information storage value B is read from the EEPROM 6. At step S10, the software unique information storage value B is sent to the diagnostic device 7.

Therefore, the software unique information storage value B (the program's or data's version code, or the parts code), not the CVN value, is displayed to the operator of the diagnostic device 7. Therefore, the operator of the diagnostic device 7 can determine that the software has been rewritten.

Next, at steps S11 and 12, the CVN calculation is performed with respect to all the storage areas in the flash memory 5, similarly to steps S6 and S7 described above. When this calculation ends, the processing advances to step S13.

At step S13, the software unique information A is read from the flash memory 5. At step S14, this software unique information A is written over the software unique information storage value B in the EEPROM 6 to update it. When the software unique information A and the software unique information storage value B stored in different storage units do not match each other, the software (program or data) is updated, and at the same time, the above-mentioned code is modified. Therefore, the software unique information storage value B is updated with the new code. It should be noted that the software unique information A may be modified when the flash memory 5 has been illegitimately altered. In that case, since the software unique information A was sent to the diagnostic device 7 at step S10, the operator can judge whether or not the code is legitimate.

Next, at step S15, the CVN calculation result that was obtained in the loop at steps S11 and S12 mentioned above is sent to the diagnostic device 7. At this time, the operator of the diagnostic device 7 can confirm that the CVN was modified, and can investigate whether or not this CVN value is the legitimate one.

Finally at step S16, the above-mentioned CVN calculation result is written over the CVN calculation storage value in the EEPROM 6 to update it. Thus, when the rewriting of the flash memory 5 is legitimate such as from updating the software, the CVN calculation storage value becomes the legitimate CVN value that corresponds to the update, and the next time the diagnosis is performed, the sending of the CVN can be performed quickly. On the other hand, if the rewriting of the flash memory 5 is illegitimate, the CVN calculation storage value is read from the diagnostic device 7 or the like and compared with the legitimate value, whereby illegitimacy can be determined easily and quickly without waiting for the CVN calculation each time.

As described above, when it is determined that the program and data in the flash memory 5 have not been rewritten, the CVN calculation storage value stored in the EEPROM 6 which is provided separately from the flash memory 5 is first sent to the diagnostic device 7, whereby the value of the CVN can be displayed quickly to the operator. Further, when the CVN calculations end, the CVN calculation result is sent to the diagnostic device 7, thereby guaranteeing reliability.

Furthermore, when the flash memory 5 has not been rewritten (normal case), the CVN calculation storage value in the EEPROM 6 is just sent to the diagnostic device 7 without being updated. Therefore, the EEPROM 6 is not rewritten many times, thus extending the life of its elements.

On the other hand, in the case where it is judged that the program and the data in the flash memory 5 have been rewritten, first, the software unique information A is sent to the diagnostic device 7, whereby the operator of the diagnostic device 7 can recognize that the flash memory 5 was rewritten, and can also verify whether or not the software unique information A is from legitimate updating, etc. Further, when the CVN calculations end, the CVN calculation result is sent to the diagnostic device 7, so that the operator can consider whether the CVN calculation result for the software unique information A that was first displayed is correct.

Since the software unique information storage value B and the CVN calculation storage value, which are in the EEPROM 6, are rewritten only in the case where the software has been rewritten, the rewriting is performed only when necessary, thus minimizing unnecessary writing, and extending the life of the elements.

Further, the device is provided with both the flash memory 5 storing the program and data used in the controls, and the EEPROM 6 storing the verification data (the CVN calculation result storage value, and the software unique information storage value B). Therefore, even when the program or data are illegitimately altered as shown in the above-mentioned conventional example, the content of the EEPROM 6 is not rewritten. Thus, when the diagnostic device 7 is connected, the rewriting of the flash memory 5 can be detected easily from the difference between the software unique information A and the software unique information storage value B.

It should be noted that, in the above-mentioned present invention, in the processing at step S15, the CVN calculation result is sent to the diagnostic device 7. However, in addition to the CVN calculation result, it is also possible to send the CVN calculation storage value in the EEPROM 6 and display the two CVN values in the display portion 70 of the diagnostic device 7.

Further, in the above-mentioned embodiment, the software used for the controls is stored in the flash memory 5, and the verification data is stored in the EEPROM 6. However, the two storage units may be the same type of storage units.

Furthermore, in the descriptions above, an example is shown in which the software and the verification data are stored in the flash memory 5 and the EEPROM 6. However, any rewriteable storage unit is acceptable. In addition to the above example, it is also possible to use an MRAM (Magnetoresistive Random Access Memory), an FeRAM (Ferroelectric Random Access Memory), a hard disk, a CD-RW, a DVD-RAM, a DVD-RW, a DVD+RW, or any other such storage unit.

This application claims priority to Japanese Patent Application No. 2003-287964. The entire disclosure of Japanese Patent Application No. 2003-287964 is hereby incorporated by reference.

The present invention is not restricted to the embodiment described above, and various alterations, improvements, etc. feasible by a person skilled in the art are included in the scope recited in the claims.

1. A control device with rewriteable control data, comprising:
a first storage unit that stores one of a program and data and is constituted in a rewriteable fashion;
a CVN calculating unit that calculates a content guaranteeing value for guaranteeing a content of the first storage unit;
a second storage unit that stores a reference value of the content guaranteeing value and is constituted in a rewriteable fashion;
a rewrite determining unit that determines that the first storage unit was rewritten;
a first verifying unit that, when the determining unit determines that the first storage unit was not rewritten, outputs the reference value stored in the second storage unit before the CVN calculating unit performs the calculation, and outputs a calculation result; and
a second verifying unit that, when the determining unit determines that the first storage unit was rewritten, outputs the calculation result after the calculation of the CVN calculating unit is complete.

2. The control device according to claim 1, wherein the second verifying unit updates the reference value with the calculation result from the CVN calculating unit.

3. The control device according to claim 1, wherein:
the first storage unit stores a first unique code corresponding to one of the program and the data;
the second storage unit stores a second unique code corresponding to the first unique code; and
the determining unit determines that the first storage unit was rewritten when the first unique code and the second unique code are different.

4. The control device according to claim 3, wherein the second verifying unit outputs the second unique code from the second storage unit, and then outputs the calculation result calculated by the CVN calculating unit.

5. The control device according to claim 4, wherein the second verifying unit writes the first unique code from the first storage unit to the second unique code in the second storage unit.

6. A control method for a control device with rewriteable control data, comprising:
a first storage step for storing one of a program and data in a first storage unit constituted in a rewriteable fashion;
a CVN calculation step for calculating a content guarantee value for guaranteeing a content of the first storage unit;
a second storage step for storing a reference value of the content guaranteeing value in a second storage unit that is constituted in a rewriteable fashion;
a determination step for determining that the first storage unit was rewritten;
a first verification step for, when it is determined in the determination step that the first storage unit was not rewritten, outputting the reference value stored in the second storage unit before the CVN calculation step and outputting a calculation result; and
a second verification step for, when it is determined in the determination step that the first storage unit was rewritten, outputting the calculation result after the CVN calculation step is complete.
